(19) United States
(12) Patent Application Publication
(10) Pub. No.: US 2024/0161157 A1
(43) Pub. Date: May 16, 2024

(54) SYSTEM, METHOD, APPARATUS, AND COMPUTER PROGRAM PRODUCT FOR PROVIDING DIGITAL CONCIERGE SERVICES

(71) Applicants: Whitney Lechelle Thomas, Dacula, GA (US); Ciera Shardae Freeman, Dacula, GA (US)

(72) Inventors: Whitney Lechelle Thomas, Dacula, GA (US); Ciera Shardae Freeman, Dacula, GA (US)

(21) Appl. No.: 18/054,961

(22) Filed: Nov. 14, 2022

(51) Int. Cl. G06Q 30/02; G06Q 10/02; G06Q 50/30

(52) U.S. Cl. CPC G06Q 30/0282; G06Q 10/02; G06Q 50/30

(57) ABSTRACT

A system, apparatus, method, and computer program product to provide digital concierge services is disclosed. The digital concierge application facilitates quality decision making for everyday life. The digital concierge services include listing clear and concise details about one or more venues, providing the means to navigate to a selected venue directly through the application, invoking a ride sharing service for transportation to the selected venue, and providing the capability to produce a live feed from that venue.

### BACKGROUND OF THE INVENTION

The present invention relates to entertainment, and more particularly to digital concierge services.

A recurring problem for many individuals is a lack of accessibility and/or efficiency to find activities to do, places to go and events happening in any given location at any given time.

Other applications fail to provide real-time data and efficiency. In many cases the other applications provide fragmented or dated information about a venue, which in turn requires their users to seek information from multiple applications in an effort to gain a complete and accurate account of that location. Often, they fail to provide useful navigation to that location. In most instances, the other applications fail to provide the ability to view live feed from that venue. None of these services provide all of these elements in one space.

As can be seen, there is a need for improved systems, apparatus, and method to provide an easy to use one stop digital concierge that provides its users with useful information regarding a given location, options to navigate to that location, and the ability to view and or post live feed from that location. This gives users a clear and concise account of the venue which they haven't been afforded in the past.

### SUMMARY OF THE INVENTION

In one aspect of the present invention, a digital concierge system is disclosed. The digital concierge system includes: a server executing computer program code to host a digital concierge service. The server has at least one processor and at least one memory. Computer program code executing on the server provide instructions via a communications network, to generate on a display of a first user computing device, a first user interface comprising a venue search functionality configured to receive a first user input for selecting a desired venue. One or more of a a geographic location of a desired venue and a venue category are received at the server from the first user computing device. A venue database, in communication with the server, is searched to match one or more venues with one or more of the geographic locations of the desired venue and the venue category. An itemized list of one or more matching venues based on the venue category and a geographic proximity of the one or more matching venues with the geographic location of the first user computing device is presented. A selected venue from the itemized list of the one or more matching venues is received at the server from the first user computing device. One or more venue information items associated with the venue are retrieved from the venue database, by the server. A venue detail user interface presenting the one or more venue information items associated with the venue and one or more GO controls selectable by the user to obtain assistance to go to the selected venue are displayed on the first user computing device. An activation of the one or more GO control icons generates on the display of the first user computing device, assistance based on a selected of the one or more GO controls.

In some embodiments, the one or more GO controls include a navigation control, wherein computer program code executing on the server provide instructions via the communications network, to generate on the display of the first user computing device, a map display and one or more guidance instructions to proceed to the selected venue. The one or more guidance instructions may be provided based on a selected mode of transportation.

In some embodiments, the one or more GO controls includes a ride share hailing control to initiate an activation of a ride sharing application installed on the first computing device. The ride share hailing option control may be encoded to automatically transmit a current location for a pick-up by the ride sharing service and the geographic coordinates of the selected venue.

In some embodiments, the digital concierge system includes receiving, via the communications network, a validation that the user is present at the selected venue. Responsive to the validation, a GO LIVE control is activated on the display of the first user computing device. Activation of the GO LIVE control allows the first user computing device to generate a live user feed. The validation may include a correspondence between a geographic location of the first computing device with geographic coordinates of the selected venue.

In some embodiments, the live user feed is stored in the venue database with the venue information items of the selected venue.

In some embodiments, a representation of the live user feed is presented on a second display of a second user computing device along with the one or more information items associated with the venue.

In yet other embodiments, a rating control is generated on the display of the first user computing device, responsive to the validation. The rating control is operable to select a rating of the selected venue. The rating of the selected venues stored in the venue database.

These and other features, aspects and advantages of the present invention will become better understood with reference to the following drawings, description and claims.

### BRIEF DESCRIPTION OF THE DRAWINGS

FIG. 1: is a flow chart of the digital concierge.

FIG. 2: is a screen shot of a home page for the digital concierge.

FIG. 3: is a screen shot of a search functionality for the digital concierge.

FIG. 4: is a screen shot of the itemized venue list for the digital concierge.

FIG. 5: is a screen shot of the venue details page for the digital concierge.

FIG. 6: is a screen shot of the venue live tab for the digital concierge.

FIG. 7: is a screen shot of the mapped venue listing for the digital concierge.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method, apparatus, and computer program product for a digital concierge service that provides real-time data and efficiency. The invention is a digital one stop concierge service which includes useful information on a given location, options to navigate to that location, and the ability to view and or post a live feed from that location. This gives users a clear and concise account of the venue.

The digital concierge service of the present invention includes all tthese components include including listing clear and concise details about the venue accessible on the application; providing the user means to navigate to that venue directly through the application, and the capability to present a live feed from that venue through the digital concierge application. The present invention seamlessly integrates these components to facilitate efficient decision making, based on an accurate account of the venue.

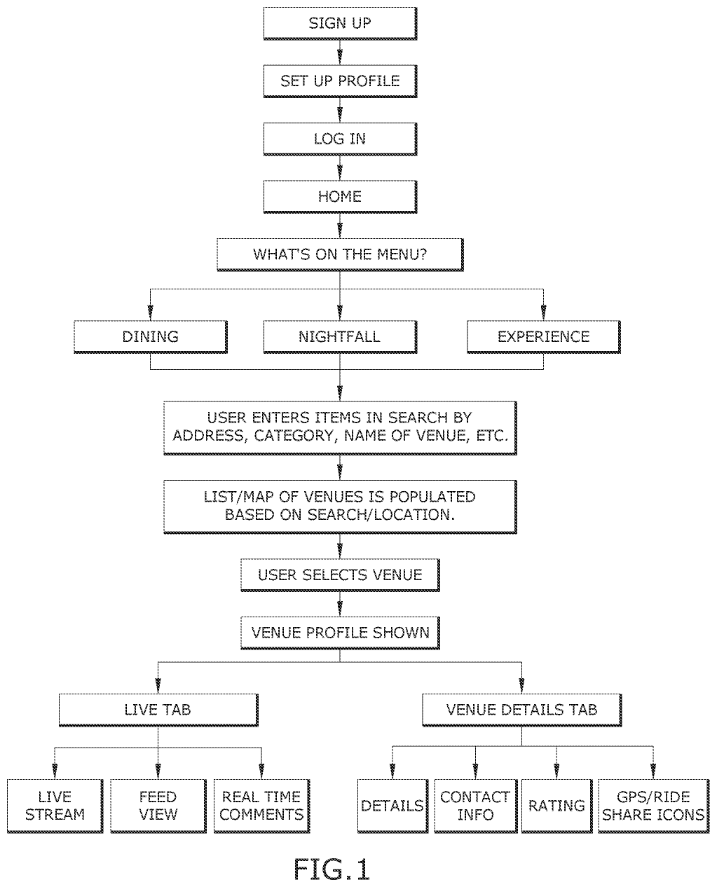

As seen in reference to the drawings of FIGS. 1-7, the digital concierge of the present invention will fill the void the left by the other concierge applications that do not have the capacity to house all three components.

A flowchart of the present invention is shown in reference to FIG. 1. Upon the initial opening of the application, users will be presented with two icons. A first icon one is a “Log In” for those users who have previously logged into the app and already have a verified account. A second icon is a “Sign Up” that may be selected by the users who would like to establish an account with the digital concierge service. The user will be prompted to create a valid username, password, and establish a profile. The users will then be required to enter their email address. The email address will then be used to verify the creation of users account before moving forward in the setup process.

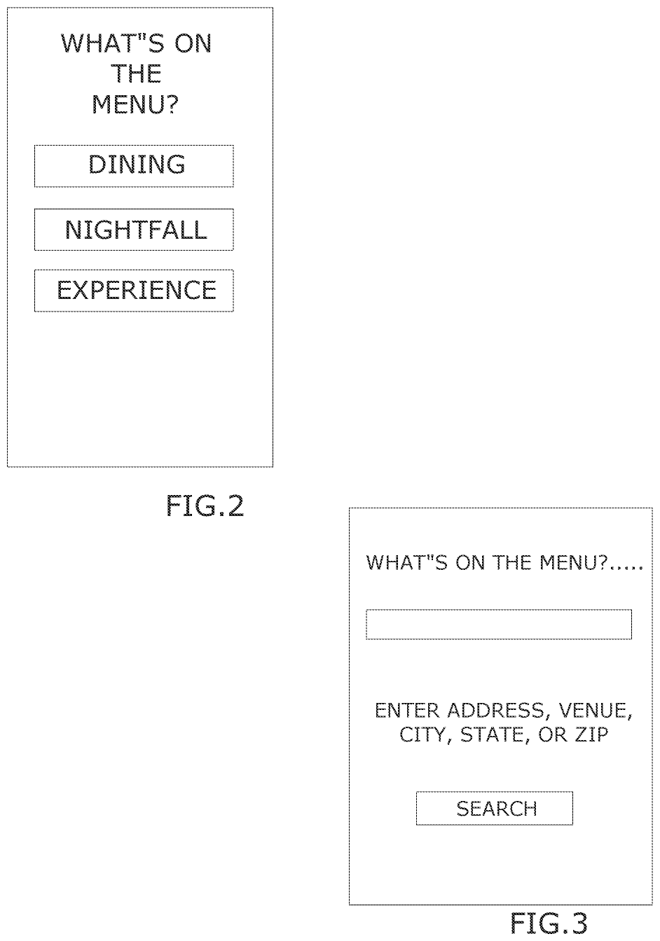

Once users have successfully signed up, they will be presented at a home page, such as shown in FIGS. 2 and 3. The home page includes a search functionality where the user may input a specific venue, an address, a city, or state. The search functionality may also include multiple filter controls to search for a venue based on one of multiple categories. By way of non-limiting example, the filter control may set a dining filter to search dining venues, a nightfall filter to select various night life venues; and an experience filter to search different theme-based events (e.g., trivia, comedy, etc.).

The search functionality is operable to search a venue database containing information items on each of a plurality of venues. The information items may include a venue name, a venue logo, a geographic location of the venue, a telephone number for the venue, a universal resource locator (URL) for the venue; a link to one or more social media pages associated with the venue; and a venue category associated with one or more goods or services provided by the venue.

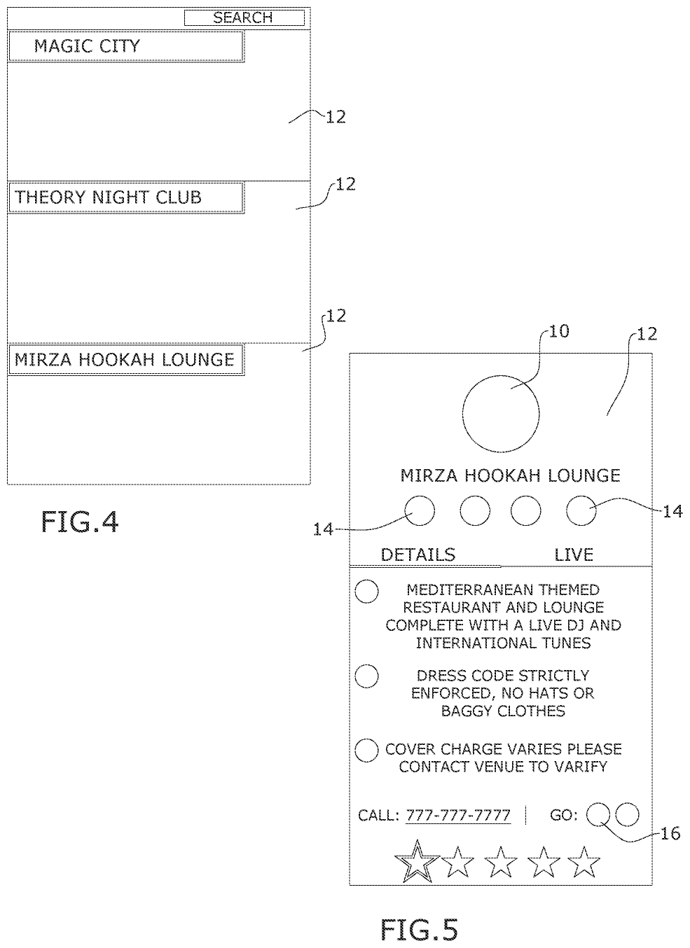

In the case of a dining filter selection, the search functionality returns an itemized list of several venues 12, such as shown in FIG. 4. The itemized list of venues 12 may be presented based on a geographic proximity to one of a selected location or a geographic location of the user's device. Preferably, the itemized list will start with the closest venue 12 and end with the furthest. In some embodiments, the user will have the ability to view these dining venues 12 as a pin-point map format, such as shown in FIG. 7.

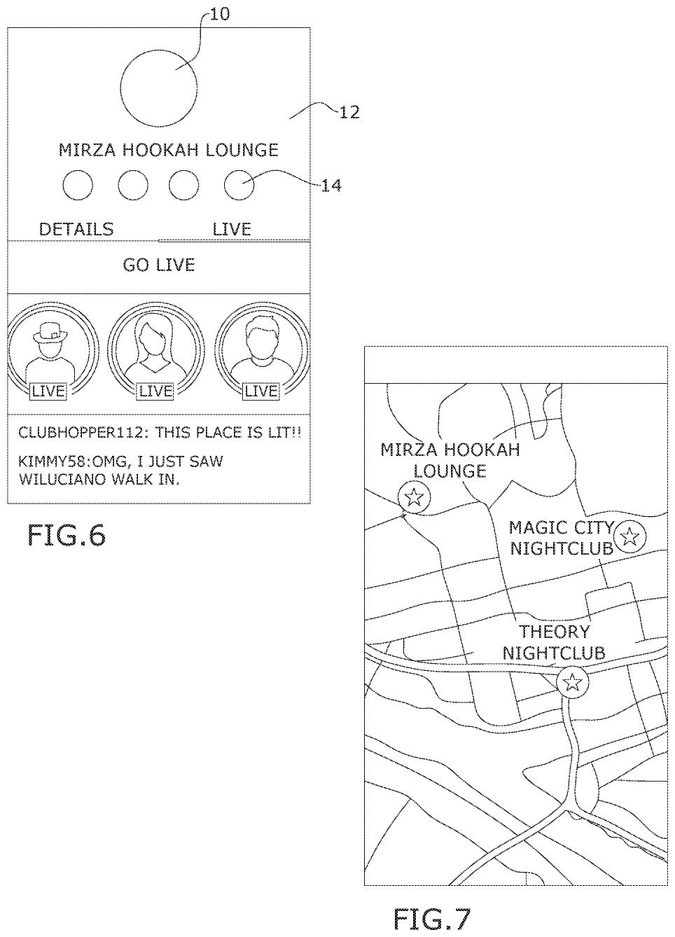

Once the user has selected the venue 12 of their choosing, a venue profile, such as shown in FIGS. 5 and 6 is presented. Once on the venue's profile, the user will see the venue's name and or logo 10, such as seen in FIG. 5, along with the social media icons 14 that serve as links to that venue's social media accounts. If the user wishes to view a particular social media account for the prospective venue, the user can simply select that icon 14, and view the selected social media page for that venue.

Underneath the social media icons 14 are two viewing options. A first option includes a “Details” tab where users will be presented a brief description of the venue's details, such as shown in FIG. 5. The venue detail tab presents a venue detail information about the venue such as cuisine type, required attire, possible cover charges, and the like. The details tab may also include a link to the venue's phone number that can be called directly from the link. The venue detail tab may also have links in the form of a GO control icon 16 to access navigation instructions or a ride share hailing option to the selected venue. Users will also be able to see the current rating of this venue.

Selection of the navigation instructions control will provide a map and guidance instructions for the user to travel from their current location to the selected venue. The map and guidance instructions may be integrated with a selected mode of travel, such as driving, walking, or public transit. Selection of the ride share hailing option enables activation of the user's installed ride sharing application. The ride share hailing option control may be encoded to automatically transmit the user's current location for pick-up by the ride sharing service and provide the address and/or geographic coordinates of the selected venue. An API may allow for seamless integration of the digital concierge with the ride sharing service application.

Should the user select the “Live” tab they will be presented information, such as shown in FIG. 6, to view real time comments and feeds posted within a specified temporal period, such as the last 23 hours, or present live feeds from users that are currently streaming from that location. A “GO LIVE” control allows the user to record and submit their own video from the venue once they have been verified to be at the venue's location. The verification may be based on a correspondence of the geographic coordinates of the user device with that of the venue, a Wi-Fi or other wireless communications network at the venue, or a near field communication (NFC) reading of the user's device at an entry to the venue.

Upon verification of arrival at the venue, users will be able to create and interact with the live feed information stored and presented on the venue's profile. After partaking in the experience of the venue, users will be encouraged to rate the venue.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A digital concierge system, comprising:
a server executing computer program code to host a digital concierge service, the server having at least one processor and at least one memory;
computer program code executing on the server providing instructions via a communications network, to generate on a display of a first user computing device, a first user interface comprising a venue search functionality configured to receive a first user input for selecting a desired venue;
computer program code executing on the server receiving, via the communications network, one or more of a geographic location of a desired venue and a venue category, from the first user computing device and;
computer program code executing on the server, searching a venue database, in communication with the server, to match one or more venues with one or more of the geographic locations of the desired venue and the venue category;
computer program code executing on the server providing instructions via the communications network, to generate on the display of the first user computing device, an itemized list of one or more matching venues based on the venue category and a geographic proximity of the one or more matching venues with the geographic location of the first user computing device;
computer program code executing on the server receiving, at the server via the communications network, a selected venue from the itemized list of the one or more matching venues from the first user computing device;
computer program code executing on the server retrieving, from the venue database, one or more venue information items associated with the venue;
computer program code executing on the server providing instructions via the communications network, to generate on the display of the first user computing device, a venue detail user interface presenting the one or more venue information items associated with the venue, and one or more GO controls selectable by the user to obtain assistance to go to the selected venue;
computer program code executing on the server receiving, via the communications network, an activation of the one or more GO control icons; and
computer program code executing on the server providing instructions via the communications network, to generate on the display of the first user computing device assistance based on a selected of the one or more GO controls.

2. The digital concierge system of claim 1, the one or more GO controls comprising:
a navigation control, wherein computer program code executing on the server provide instructions via the communications network, to generate on the display of the first user computing device, a map display and one or more guidance instructions to proceed to the selected venue.

3. The digital concierge system of claim 2, wherein the one or more guidance instructions are provided based on a selected mode of transportation.

4. The digital concierge system of claim 1, the one or more GO controls comprising:
a ride share hailing control, wherein computer program code executing on the server provide instructions via the communications network, to generate on the first user computing device, an activation of a ride sharing application installed on the first computing device.

5. The digital concierge system of claim 4, wherein ride share hailing option control is encoded to automatically transmit a current location for a pick-up by the ride sharing service and the geographic coordinates of the selected venue.

6. The digital concierge system of claim 1, further comprising:
computer program code executing on the server receiving, via the communications network, a validation that the user is present at the selected venue;
computer program code executing on the server providing instructions via the communications network, to generate a GO LIVE control on the display of the first user computing device,
computer program code executing on the server receiving, via the communications network, an activation of the GO LIVE control;
computer program code executing on the server providing instructions via the communications network, to generate a live user feed from the first user computing device.

7. The digital concierge system of claim 6 wherein the validation comprises a correspondence between a geographic location of the first computing device with geographic coordinates of the selected venue.

8. The digital concierge system of claim 6, further comprising:
computer program code executing on the server, storing the live user feed in the venue database with the venue information items of the selected venue.

9. The digital concierge system of claim 7, further comprising:
computer program code executing on the server providing instructions via the communications network, to generate on a second display of a second user computing device, a representation of the live user feed with the one or more information items associated with the venue.

10. The digital concierge system of claim 6, further comprising:
computer program code executing on the server providing instructions via the communications network, to generate a rating control on the display of the first user computing device, the rating control operable to select a rating of the selected venue; and
computer program code executing on the server receiving, via the communications network, the rating of the selected venue; and
computer program code executing on the server storing the rating in the venue database.
